(19) United States
(12) Patent Application Publication
(10) Pub. No.: US 2020/0051390 A1
(43) Pub. Date: Feb. 13, 2020

(54) EXTENDED PLAY VIDEO SLOT MACHINE AND METHOD

(71) Applicant: Kathleen Nylund Jackson, Newport, NC (US)

(72) Inventor: Kathleen Nylund Jackson, Newport, NC (US)

(21) Appl. No.: 16/056,836

(22) Filed: Aug. 7, 2018

(51) Int. Cl. G07F 17/32; G07F 17/34; G06Q 50/34

(52) U.S. Cl. CPC G07F 17/3267; G06Q 50/34; G07F 17/3211; G07F 17/34

(57) ABSTRACT

An apparatus and method for an extended play video slot machine is disclosed. A predetermined number of single-line reel slot games and a multiline game are displayed, wherein the said multiline game comprises a number of symbol areas arranged in a column×row grid. The total number of symbols in the total number of single-line reel games equals the total number of symbol areas in the multiline game. A first paytable for the single-line reel games and a second paytable for the multiline game are provided. The single-line reel games are sequentially played, with awards being provided for any winning symbol outcomes. The same said symbols are replicated into vacant symbol areas in the multiline game. After all single-line reel game outcomes have been completed, thereby populating each and every symbol area in the multiline game, the multiline game is then evaluated for wins.

### RELATED APPLICATION DATA

This application claims priority from U.S. Provisional Patent Application Ser. No. 62/606,007, filed Sep. 5, 2017, and having the Title EXTENDED PLAY VIDEO SLOT MACHINE AND METHOD.

### BACKGROUND OF THE INVENTION

### 1. Field of the Invention

The present invention relates to a video slot symbol game and apparatus suitable for use in casinos and other gaming enterprises. The invention further relates to video gaming play that provides an extended play method with multiple pay opportunities.

### 2. Background of the Art

Video slot games have grown exponentially in numbers in the last twenty-five years, as have the revenues generated by such devices. It is estimated that more than 70% of any casino's revenue are now provided by gaming machines as opposed to table games.

In the gaming industry, there is a continuous need for innovative game features that will attract new players as well as keep regular players amused and therefore willing to continue playing the game. Since in virtually every casino game there is a house advantage, the longer a player remains playing at a machine, the larger the casino's profit. And since it is well recognized in the industry that players tend to easily tire of playing the same games over and over again, manufacturers must constantly develop new game features to stimulate player interest.

In addition to the house benefiting from longer player time on machine, casinos have traditionally required games that are designed to be completed in very few seconds, typically approximately three seconds, since the more games played per hour, the more revenues for the casino. The downside to this scheme is that there is little time to build excitement and anticipation, which are the hallmarks of the gambling urge.

A similar dilemma is found in lottery gaming. Most instant lottery tickets can be scratched off in a mere 20 seconds or less, leaving some players unsatisfied. To counteract this, some newer extended play instant tickets provide three to five minutes of play, with games that provide escalating excitement and anticipation. Even though the fast play tickets still dominate the market, a dedicated smaller number of players find these extended play tickets irresistible. In Massachusetts, for example, the country's most lucrative lottery in terms of revenue, the best-selling ticket in 2015 was the extended play $2 Cashword®, although it is estimated that only 15%-20% of players chose to play them.

It is desired to provide a novel casino video slot game that takes longer to play, provides escalating excitement and anticipation, and that will still provide the revenues that the casino requires.

Prior art has taught various methods of novel casino video slot games that provide multiple games or grids and/or transferred or replicated slot symbols.

U.S. Pat. No. 6,159,095 (Frohm, et al.) discloses an electronic video gaming machine for playing multiple games. The gaming machine includes a first set of game elements for playing a game having a plurality of possible game outcomes. A first game outcome is selected from a plurality of possible game outcomes including at least one predetermined carry-over outcome. The carry-over outcome occurring in the first game outcome is automatically duplicated by the processor into at least one other game outcome.

U.S. Pat. No. 7,527,557 (Jackson) describes a method of playing a wagering game that comprises a player placing a wager in a gaming machine. The machine has more than one symbol display system comprising a first symbol display area and at least a second symbol display area. The first display area and at least second display area displaying a plurality of symbols that are used to determine winning events. The first display area provides at least one first symbol. The first symbol is automatically provided to the at least second display area. The machine then independently completes symbol display for the first display area and the at least second display area and then determines if winning events are present in the first display area and the at least second display area.

U.S. Application No. 20140141855 (DePalma, et al.) discloses games, gaming machines, gaming systems and methods that include a primary game award at least partially based on the outcomes of one or more sub-games. The outcomes are related according to a pay table associated with the primary game.

U.S. Application No. 20130184053 (McKay, et al.) teaches a method of gaming comprising: generating a game outcome by selecting a plurality of symbols, and displaying the selected symbols on a display at respective ones of a plurality of display positions arranged in a three-dimensional array; and determining whether the game outcome includes one or more winning outcomes.

U.S. Application No. 20160125687 (Berman) describes systems, apparatuses, and methods that involve or otherwise facilitate a multiple symbol replacement process. Accordingly, a gaming device includes a display having a first game grid and a second game grid, and can be configured to replace at least two symbols in the second game grid, with each of the replaced symbols being in separate game reels that form columns in the second grid, when a predetermined symbol appears in the first game grid as part of a determined game outcome. Alternatively, the gaming device may be configured to replace symbols in the second game grid when a predetermined symbol appears in the first game grid, and replace symbols in the first game grid when a predetermined symbol appears in the second game grid.

U.S. Application No. 20150287269 (Berman) describes systems, apparatuses, and methods for providing conditional reel functionality in gaming devices. Accordingly, a gaming device can be configured to increase the variety of outcomes and sense of anticipation in a video slot game, by varying the composition of symbols on one or more reels based on outcomes of previously determined reels. In some embodiments this varying of composition occurs while the reels are still spinning. The varying of composition may be accomplished by modifying, substituting, generating, or otherwise altering symbols or the order of symbols in the one or more reels.

Despite the above referenced prior art, there remains a need for gameplay providing extended play time and unique features in order to increase player anticipation and participation.

### SUMMARY OF THE INVENTION

A video slot machine and extended play method thereof comprises providing a predetermined number of single-line reel slot games on a video display screen wherein each said reel slot game comprises a predetermined number of symbol areas and wherein the number of reels in each said reel slot game equals the number of symbol areas. Simultaneously a multi-payline slot game is displayed, wherein the said multiline slot game comprises a predetermined number of symbol areas arranged in a column×row grid wherein the total number of symbol areas in the total number of single-line reel slot games equals the total number of symbol areas in the multiline slot game. A predetermined first paytable for the single-line reel slot games and a predetermined second paytable for the multiline slot game are also provided. The player makes a wager to play all of the single-line reel games and the multiline game. Firstly, the single-line reel games are sequentially played, with awards being provided for any winning symbol combination outcomes according to the first paytable. As each single-line reel game outcome of symbols is revealed, the same said symbols are replicated into available vacant symbol areas in the multiline game. When all single-outcome reel games have been completed, each symbol area in the multiline game will be filled with a slot symbol. Secondly, the multiline slot game is then evaluated for wins according to the second paytable.

### BRIEF DESCRIPTION OF THE FIGURES

FIG. 1 shows a monitor screen of a casino slot machine with five 3-reel games and one multiline game.

FIG. 2 shows the monitor screen of the slot machine with the outcome of the first 3-reel game.

FIG. 3 shows the monitor screen of the slot machine with the outcome of the second 3-reel game.

FIG. 4 shows the monitor screen of the slot machine with the outcome of the third 3-reel game.

FIG. 5 shows the monitor screen of the slot machine with the outcome of the fourth 3-reel game.

FIG. 6 shows the monitor screen of the slot machine with the outcome of the fifth 3-reel game.

FIG. 7 shows the monitor screen of the slot machine with the outcome of the multiline slot game.

FIG. 8 shows a physical casino gaming machine capable of executing the method of the present invention.

FIG. 9 shows another gaming network that may be used to implement some aspects of the present invention.

FIG. 10 shows yet another network device that may be configured for implementing some methods of the present invention.

### DETAILED DESCRIPTION OF THE INVENTION

The technology of the present application includes a method of playing a video wagering game having multiple single-line slot games and one associated multiline slot game. The said video wagering game is played on an electronic gaming machine (EGM). A standard EGM having a housing, video display monitor, processor and a memory in communication with the processor (internal or through an I/O port to a distal memory) may be used to support the game. The method effected and steps performed on the EGM would include at least some of:

the processor accepting a physical wager by a player on the video wagering game;

displaying on the video display screen a random set of symbols used in the play of a wagering game (the display signals generated by the processor and/or memory); and

the processor determining an outcome on the wagering game based on the random set of symbols (which symbols may be electronically mapped on virtual reels and/or selected from sets of symbols by an electronic random number generator).

A video gaming apparatus comprises a housing, a video display monitor in the housing, a processor in the housing and a memory in communication with the housing, wherein the processor and memory are configured to perform the methods described above and herein and to cause the symbols of the video wagering game to be displayed on the video display screen.

A gaming system comprises a physical wager input device and at least one display for displaying a video wagering game, the wagering game comprising at least an underlying base game. At least one processor and controller are operative to detect receipt of at least one wager from a first player via the physical wager input device.

The present invention can be implemented using a variety of different processing apparatuses. Preferably, the invention is implemented using a computer to determine game operations, implement game rules, and perform accounting functions on wagers and outcomes. A typical computer includes a central processing unit connected to a memory. The computer has connected thereto other devices such as display screen, buttons and/or a touch screen input device, one or more front panel buttons used in the operation of the machine; a coin, credit, token, or card acceptor for allowing a player to place bets; a network card for connecting the computer to an optional central computer, and security system connections. The central computer may be used for accounting, bookkeeping, and/or security purposes, or for downloading new game software or game software upgrades to computer, and/or for controlling the operation of the game via a network. In one optional embodiment, the computer includes a memory having a more permanent first portion in which is stored the software for running games on a CPU. This more permanent memory may be a hard disk read only memory (ROM), erasable programmable read only memory (EPROM), an application specific integrated circuit (ASIC), field programmable gated array (FPGA) or even a feed through a network to a localized or central memory. A thin client network from the central computer or local game computer to the individual gaming device may alternatively be provided. All of these integrated circuit storage means are well known in the art so are not discussed further. The advantage to providing all game logic via a stored program on hard disk, or via network card from a central computer is that a game may quickly and easily be updated, or a different game program be loaded to run on the computer without having to change any integrated circuit chips, such as the ROMs, EPROMs or ASICs. When game software remains on the central computer, it permits games to be played over a local network, or over a remote network which may include the Internet. The memory also has a second portion used in playing the games. The second memory would be typically a random access memory (RAM) with memory locations associated with each of the primary game positions, secondary game positions, secondary game progressives, information display areas and soft buttons on a display. These memory locations store information about the game symbols displayed, the bets placed, winnings, the speed of the game, etceteras. Alternatively, individual game software may not be permanently stored in memory. When a player touches a game selection button, or reel set selection button or control, and a game or reel sets is selected for a game, the request may be transmitted via network or network card to a central computer and the game software is downloaded to the more permanent memory to be used by the CPU to run the game or reel set chosen by the player. This permits central control of the games to be played on specific machines, fast upgrades of game software and easier addition of software for new games.

In a further non-limiting configuration, one or more of the players can be located in separate locations, and the player terminals or hand-held devices or player screens in rooms can be connected to the controller via communication links (e.g., hardwired or wireless). Standard protocols, software, hardware and processor languages may be used in these communication links, without any known limitation. There are hundreds of available computer languages that may be used, among the more common being Ada; Algol; APL; awk; Basic; C; C++; Cobol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; and XML.

Any commercial processor may be used either as a single processor, serial or parallel set of processors in the system. Examples of commercial processors include, but are not limited to Merced™, Pentium™, Pentium II™, Xeon™, Celeron™, Pentium Pro™, Efficeon™, Athlon, AMD and the like.

Display screens may be segment display screen, analog display screens, digital display screens, CRTs, LED screens, plasma screens, liquid crystal diode screens, and the like.

A video slot machine and method thereof comprises: a housing; at least one display device; at least one processor; at least one physical input or input/output device configured to detect a physical item associated with a monetary amount that establishes a credit balance; at least an electronic input device; and at least one memory device which stores a plurality of instructions which, when executed by the at least one processor, cause the at least one processor to operate with the at least one display device. A predetermined number of single-line reel slot games is displayed on the display device wherein each said reel slot game comprises a predetermined number of symbol areas and wherein the number of reels in each said reel slot game equals the number of symbol areas. A multiline slot game is simultaneously displayed on the display device, wherein the said multiline slot game comprises a predetermined number of symbol areas arranged in a column×row grid wherein the total number of symbol areas in the total number of single-line reel slot games equals the total number of symbol areas in the multiline slot game. A predetermined first paytable is established for the single-line reel slot games, and a predetermined second paytable is established for the multiline slot game.

A player, using the at least one electronic physical input device, makes a wager to play all of the single-line slot games and the multiline slot game, thereby decrementing the credit balance by the amount of the wager. A first single-line reel slot game is randomly populated, preferably by spinning and stopping the reels, with slot symbols from a predetermined set of slot symbols. The outcome of the first reel spin is then evaluated according to the first paytable, and if a win is present in said first single-line slot game, an award for said win is provided. Each individual slot symbol in said first single-line reel slot game outcome is then replicated into a single available vacant symbol area in the multiline game.

A second single-line reel slot game is then randomly populated with slot symbols from the predetermined set of slot symbols. The outcome of the second reel spin is then evaluated according to the first paytable, and if a win is present in said second single-line slot game, an award for said win is provided. Each individual slot symbol in said second single-line reel slot game outcome is then replicated into a single available vacant symbol area in the multiline game.

Each next single-line reel slot game is then populated with slot symbols from the predetermined set of slot symbols until a final single-line reel slot game is completed. Any wins for each said next and final single-line slot game outcome are awarded according to the first paytable. Each individual slot symbol in each next and final game outcome is replicated into a single available vacant symbol area in the multiline game until all said symbol areas in the multiline game are filled with an individual slot symbol. The outcome of the multiline slot is then evaluated according to the second paytable, and if a win is present in said multiline slot game, an award for said win is provided. The credit balance is then incremented by the amount of any awards won in the single-line slot games and the multiline slot game.

In a first preferred embodiment of the present invention, five separate single-line 3-reel slot games are displayed on a display monitor on a video slot machine. In a separate area on the monitor screen, one 5-column×3-row multi-payline slot game is displayed. The multiline game comprises a predetermined number of paylines. A predetermined first paytable is provided for said single-line reel slot games wherein predetermined combinations of slot symbols from a predetermined set of slot symbols comprise winning outcomes. A predetermined second paytable is provided for said multiline slot game wherein predetermined combinations of slot symbols on a wagered payline comprise winning outcomes.

The player utilizes a physical input device configured to detect a physical item associated with a monetary amount or credit amount to establish a credit balance. A wager is then decremented from the credit balance. The wager comprises a monetary or credit amount to play all five of the 3-reel slot games, plus a monetary or credit amount to play at least one payline of the multiline game. The player may chose to wager any specific amount on each 3-reel game, and any specific amount on each wagered payline of the multiline game. For instance, the player may wager three credits on each 3-reel game (for a total of 15 credits), plus one credit on each of five paylines in a 5-payline multiline game (for a total of 5 credits), so that the total wager is 20 credits. (It is also contemplated that each 3-reel game and each payline in the multiline game must have the same credit amount wager. For instance, the player may wager three credits on each 3-reel game (for a total of 15 credits), plus three credits on each of ten paylines in a 15-payline multiline game (for a total of 45 credits), so that the total wager is 60 credits.)

A physical or touchscreen “PLAY” button causes the processor and/or memory to spin the reels of the first of the five single-line slot games, revealing three slot symbols from a predetermined set of slot symbols. The outcome is evaluated according to the first paytable, and if a win is present in said first single-line slot game, an award is provided. Immediately each individual slot symbol in said first single-line slot game outcome is replicated and placed into a single available vacant symbol area in the multiline game. The symbols in the outcomes of the 3-reel games may be placed randomly, pseudo randomly, non-randomly or by the most optimal position into the multiline game. It is preferred that all symbols in each 3-reel game non-winning outcome be placed randomly into the multiline game, and all symbols in each 3-reel game winning outcome be placed optimally into the multiline game.

The second 3-reel slot game is then automatically initiated and played as the first 3-reel game described above. The reels are spun and stopped, the outcome is evaluated for wins, and the symbols in the outcome are replicated and placed into available vacant positions in the multiline game. The third, fourth and fifth games are then played, with each game being evaluated for wins, and the symbols in each outcome are replicated and placed into available positions in the multiline game.

Each 3-reel game outcome comprises three symbols, and five games are played, so there are a total of 15 symbols in the completed 3-reel games. Each of the said 15 symbols have been replicated, and now completely fill the 15 symbol positions and provide an outcome in the 5×3 multiline game. The outcome of the multiline slot game is evaluated, and any wins according to the second paytable are provided as awards.

Any awards in the five 3-reel games and the multiline game are then added to the credit balance, and may be delivered to the player via the input/output device of the slot machine in the form of cash or a pay ticket.

Those trained in the art will appreciate that these play options are exemplary and are not intended to dictate an exclusive method of play, nor limit or restrict specific gameplay.

Reference to the Figures will assist in further understanding of the practice of the present invention.

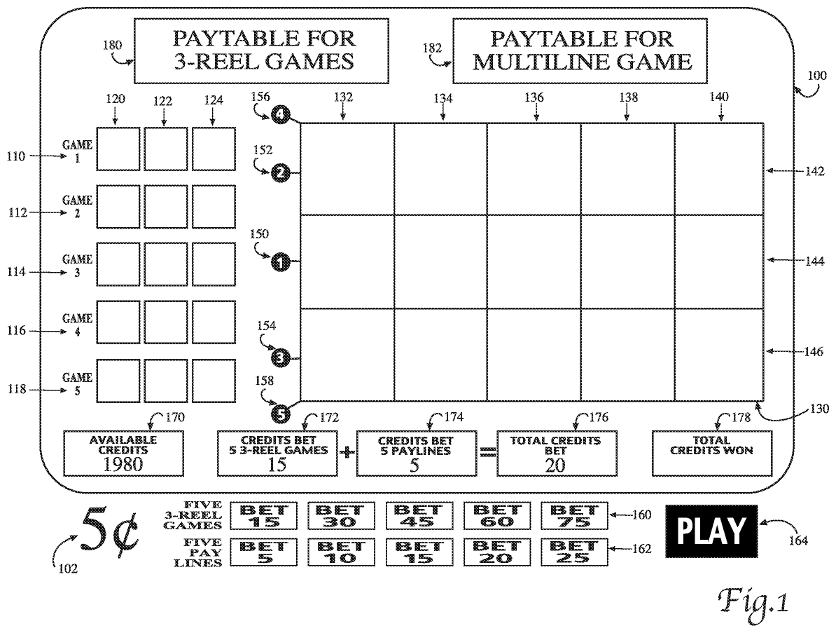

FIG. 1 illustrates the first preferred embodiment of the present invention and shows a display monitor 100 and a specific denomination to be wagered 102. Five separate 3-reel slot games (110, 112, 114, 116, 118) are displayed on the display monitor 100, each comprising a first reel symbol area 120, a second reel symbol area 122 and a third reel symbol area 124. A multiline slot game 130 is also displayed on the display monitor 100, comprising five columns (132, 134, 136, 138, 140) and three rows (142, 144, 146). Five paylines for the multiline game are shown (150, 152, 154, 156, 158). Five different betting options are shown for wagering on the 3-reel slot games 160. Five different betting options are shown for wagering on the multiline slot games 162. A PLAY button 164 that activates the wager is shown. Various boxes are shown on the display monitor are shown, including at least an AVAILABLE CREDITS box 170 indicating 1980 credits still available after the wager, a CREDITS BET AN ALL FIVE 3-REEL SLOT GAMES box 172 indicating 3 credits bet on each of five games for a total of 15 credits, a CREDITS BET PER PAYLINE box 174 for the multiline game (1 credit per payline for a total of 5 credits), a TOTAL CREDITS BET box 176 indicating a total bet of 20 credits, and a TOTAL CREDITS WON box 178. Also shown is an area for the 3-reel games paytable 180 and an area for the multiline game paytable 182.

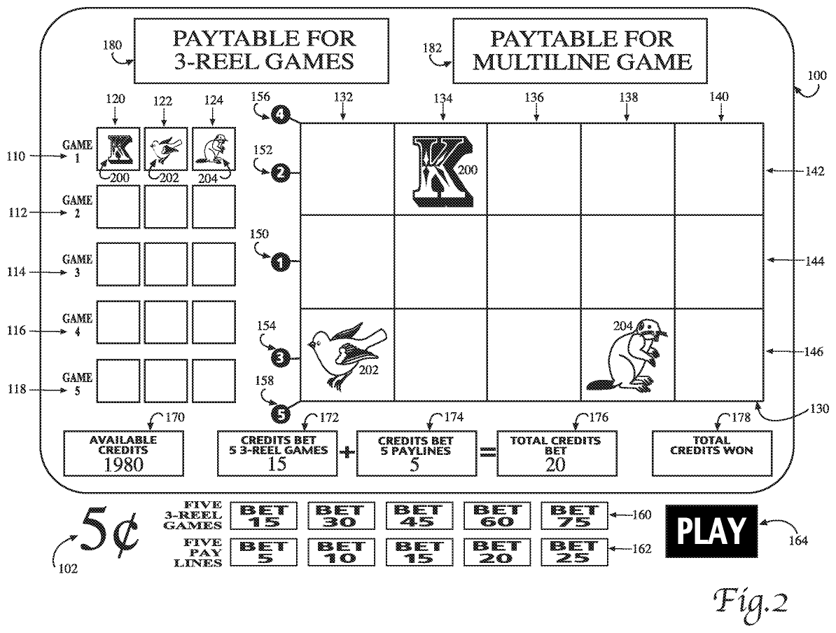

FIG. 2 refers to the game elements shown in FIG. 1 and displays the outcome of Game 1 of the 3-reel games 110 wherein the first reel 120 has been spun to reveal a K (King) symbol 200, the second reel 122 has been spun to reveal a Bird symbol 202, and the third reel 124 has been spun to reveal a Beaver symbol 204. The same said symbols (200, 202, 204) are shown replicated randomly into available vacant symbol boxes in the multiline game 130. (There is no win in the first 3-reel game, therefore the outcome symbols are randomly placed into the multiline game.)

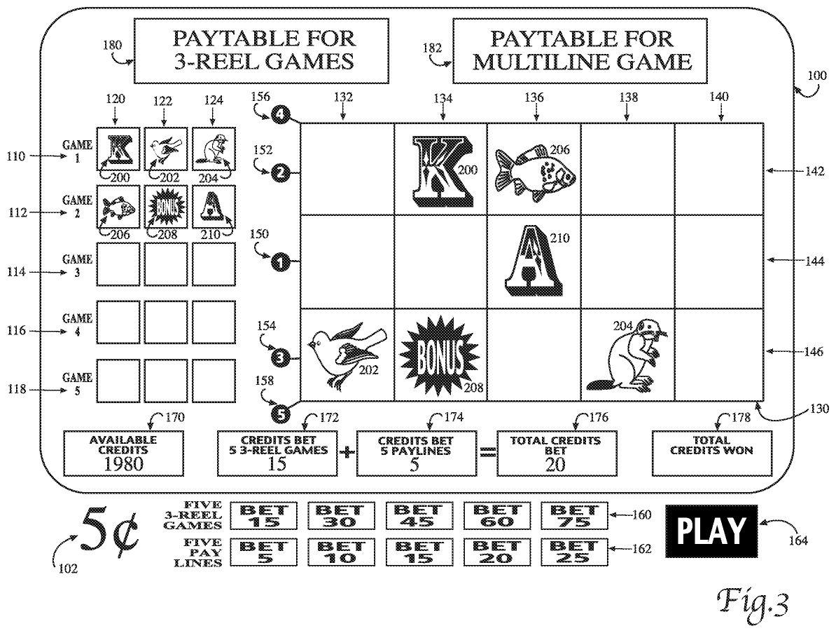

FIG. 3 refers to the game elements shown in FIG. 2 and displays the outcome of Game 2 of the 3-reel games 112 wherein the first reel 120 has been spun to reveal a Fish symbol 206, the second reel 122 has been spun to reveal a Bonus symbol 208, and the third reel 124 has been spun to reveal an A (Ace) symbol 210. The same said symbols (206, 208, 210) are shown replicated randomly into available vacant symbol boxes in the multiline game 130. (There is no win in the second 3-reel game, therefore the outcome symbols are randomly placed into the multiline game.)

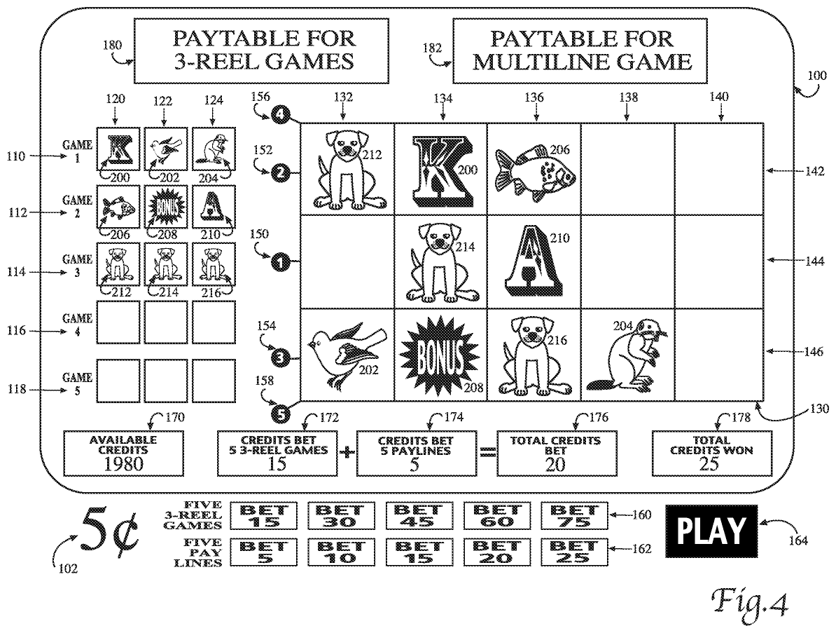

FIG. 4 refers to the game elements shown in FIG. 3 and displays the outcome of Game 3 of the 3-reel games 114 wherein the first reel 120 has been spun to reveal a Dog symbol 212, the second reel 122 has been spun to reveal a Dog symbol 214, and the third reel 124 has been spun to reveal a Dog symbol 216. The same said symbols (212, 214, 216) are shown replicated optimally into available vacant symbol boxes in the multiline game 130. (There is a win of three like symbols in the third 3-reel game, as indicated in the TOTAL CREDITS WON box 178, and therefore the outcome symbols are optimally placed into the multiline game.)

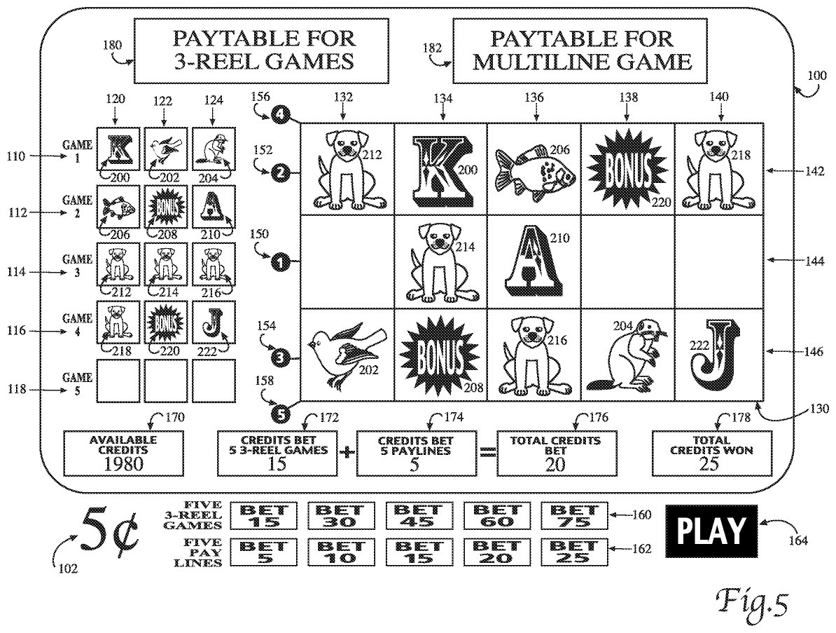

FIG. 5 refers to the game elements shown in FIG. 4 and displays the outcome of Game 4 of the 3-reel games 116 wherein the first reel 120 has been spun to reveal a Dog symbol 218, the second reel 122 has been spun to reveal a Bonus symbol 220, and the third reel 124 has been spun to reveal a J (Jack) symbol 222. The same said symbols (218, 220, 222) are shown replicated randomly into available vacant symbol boxes in the multiline game 130. (There is no win in the fourth 3-reel game, therefore the outcome symbols are randomly placed into the multiline game.) At this point in the gameplay process, there are three optimum outcomes to anticipate: 1) the player hopes for a win in the fifth 3-reel game; 2) the player hopes for at least one Bonus symbol in the fifth 3-reel game (the rules of this game version may provide a least amount of free spins if the outcome of the multiline game comprises three Bonus symbols, a greater amount of free spins if the outcome of the multiline game comprises four Bonus symbols, and a greatest amount of free spins if the outcome of the multiline game comprises five or more Bonus symbols); and 3) the player hopes for a fifth Dog symbol in the fourth payline in the multiline game.

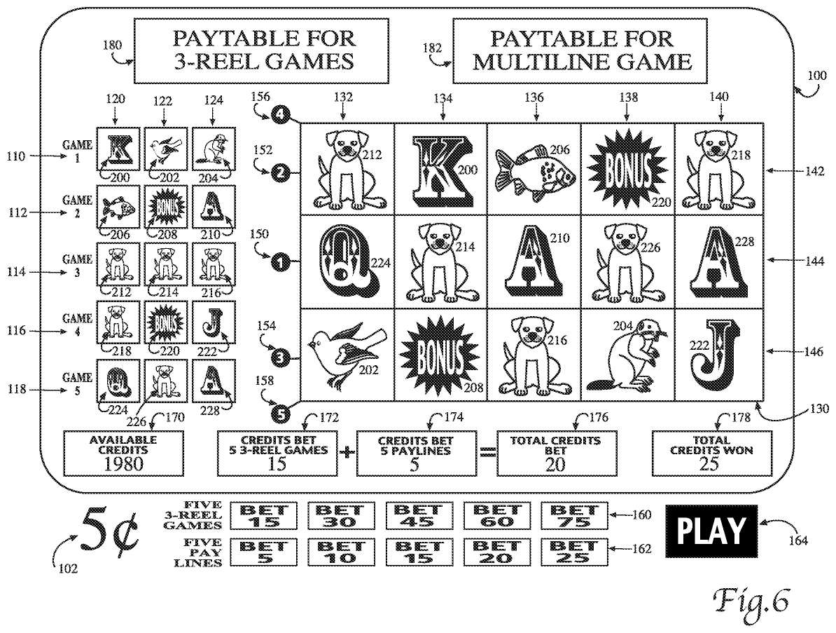

FIG. 6 refers to the game elements shown in FIG. 5 and displays the outcome of Game 5 of the 3-reel games 118 wherein the first reel 120 has been spun to reveal a Q (Queen) symbol 224, the second reel 122 has been spun to reveal a Dog symbol 226, and the third reel 124 has been spun to reveal an A (Ace) symbol 228. The same said symbols (224, 226, 228) are shown replicated randomly into the final three available vacant symbol boxes in the multiline game 130. (There is no win in the fourth 3-reel game, therefore the outcome symbols are randomly placed into the multiline game.) The multiline game outcome is now determined.

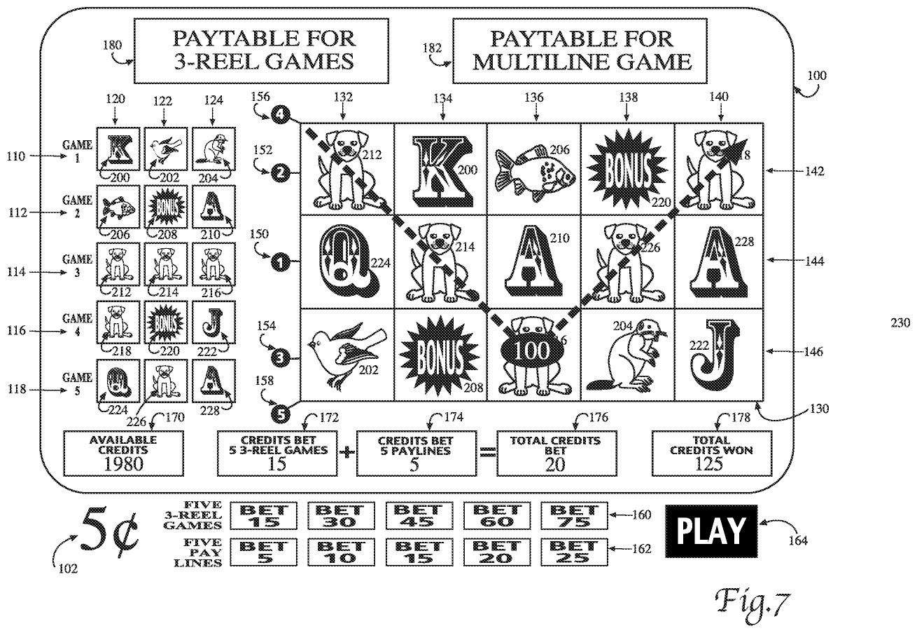

FIG. 7 refers to the game elements shown in FIG. 6 and displays one winning payline (Payline #4) 156 that comprises five Dog symbols (212, 214, 216, 226, 218) for a win of 100 credits. The 100-credit win is added to the TOTAL CREDITS WON box 178, for a total game win of 125 credits.

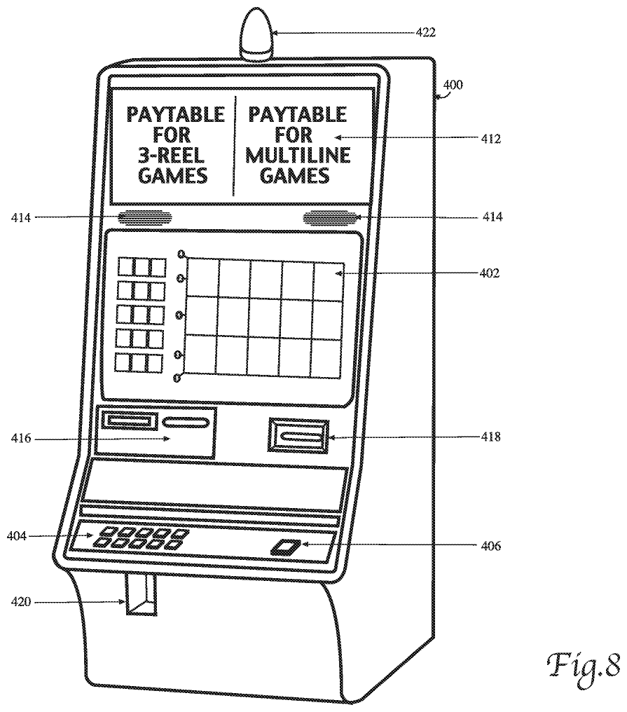

FIG. 8 illustrates a gaming machine that includes at least a cabinet 400 and monitor screen 402 capable of displaying a video gambling game. The gaming machine comprises at least physical buttons 404 that enable a player select a specific wager amount, and a physical PLAY GAME button 406. An additional video monitor screen 412 may be provided, upon which paytables or instructions may be displayed. The gaming machine or apparatus preferably also includes speakers 414, and a value input/output device 416 that allows a player to insert value for game play or extract value of said game play. A separate device 418 is provided that preferably enables a player card or ticket to be inserted for the purpose of keeping track of player information, providing information of benefits or events, and the like. In rarer or older examples, a coin output device 420 may be provided. An electronic signaling device 422 may be apportioned on the top of the gaming machine to signal information of wins or needs to the appropriate people or employees.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches, the video display screen or using some other device which enables a player to input information into the gaming machine. In some embodiments, the player may be able to access various game services such as concierge services and entertainment content services using the video display screen and one more input devices.

During certain game events, the gaming machine may display visual and auditory effects that can be perceived by the player. These effects add to the excitement of a game, which makes a player more likely to continue playing. Auditory effects include various sounds that are projected by the speakers. Visual effects include flashing lights, strobing lights or other patterns displayed from lights on the gaming machine or from lights within the separate mechanical (or electronic) separately, individually wagerable gaming system. After the player has completed a game, the player may receive game tokens from the coin tray or the ticket from the printer, which may be used for further games or to redeem a prize. Further, the player may receive a ticket for food, merchandise, or games from the printer.

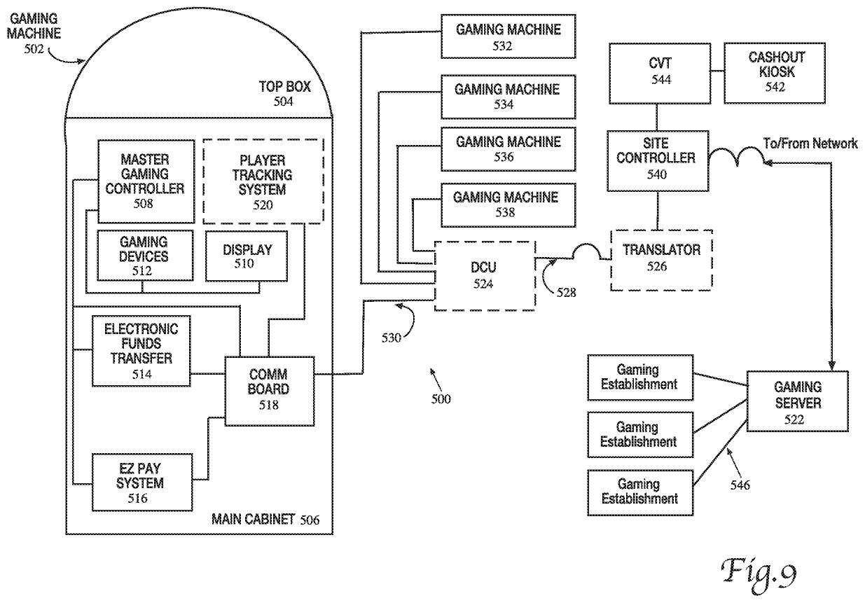

Another gaming network that may be used to implement some aspects of the invention is depicted in FIG. 9. Gaming establishment 500 could be any sort of gaming establishment, such as a casino, a card room, an airport, a store, etc. In this example, gaming network 546 includes more than one gaming establishment, all of which are networked to game server 522. Here, gaming machine 502, and the other gaming machines 532, 534, 536 and 538, include a main cabinet 506 and a top box 504. The main cabinet 506 houses the main gaming elements and can also house peripheral systems, such as those that utilize dedicated gaming networks. The top box 504 may also be used to house these peripheral systems.

The master gaming controller 508 controls the game play on the gaming machine 502 according to instructions and/or game data from game server 522 or stored within gaming machine 502 and receives or sends data to various input/output devices 512 on the gaming machine 502. In one embodiment, master gaming controller 508 includes processor(s) and other apparatus of the gaming machines described above. The master gaming controller 508 may also communicate with a display 510.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 508 may also communicate with EFT system 514, EZPay™ system, and player tracking system 520. The systems of the gaming machine 502 communicate the data onto the network 522 via a communication board 518 and transmittal line 530.

It will be appreciated by those of skill in the art that embodiments of the present invention could be implemented on a network with more or fewer elements than are depicted in FIG. 9. For example, player tracking system 520 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 524 and translator 526 are not required for all gaming establishments 500. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Furthermore, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 540 provides this function for gaming establishment 546. Site controller 540 is connected to a central system and/or other gaming establishments via one or more networks, which may be public or private networks. Among other things, site controller 540 communicates with game server 522 to obtain game data, such as ball drop data, bingo card data, etc.

In FIG. 9, gaming machines 532, 534, 536 and 538 are connected to a dedicated gaming network 522. In general, the DCU 524 functions as an intermediary between the different gaming machines on the network 522 and the site controller 540. In general, the DCU 524 receives data transmitted from the gaming machines and sends the data to the site controller 540 over a transmission path 528. In some instances, when the hardware interface used by the gaming machine is not compatible with site controller 540, a translator 526 may be used to convert serial data from the DCU 524 to a format accepted by site controller 540. The translator may provide this conversion service to a plurality of DCUs.

Further, in some dedicated gaming networks, the DCU 524 can receive data transmitted from site controller 540 for communication to the gaming machines on the gaming network. The received data may be, for example, communicated synchronously to the gaming machines on the gaming network.

Here, CVT 544 provides cashless and cashout gaming services to the gaming machines in gaming establishment 546. Broadly speaking, CVT 544 authorizes and validates cashless gaming machine instruments (also referred to herein as “tickets” or “vouchers”), including but not limited to tickets for causing a gaming machine to display a game result and cash-out tickets. Moreover, CVT 544 authorizes the exchange of a cashout ticket for cash. These processes will be described in detail below. In one example, when a player attempts to redeem a cash-out ticket for cash at cashout kiosk 1044, cash out kiosk 542 reads validation data from the cashout ticket and transmits the validation data to CVT 544 for validation. The tickets may be printed by gaming machines, by cashout kiosk 542, by a stand-alone printer, by CVT 544, etc. Some gaming establishments will not have a cashout kiosk 542. Instead, a cashout ticket could be redeemed for cash by a cashier (e.g. of a convenience store), by a gaming machine or by a specially configured CVT.

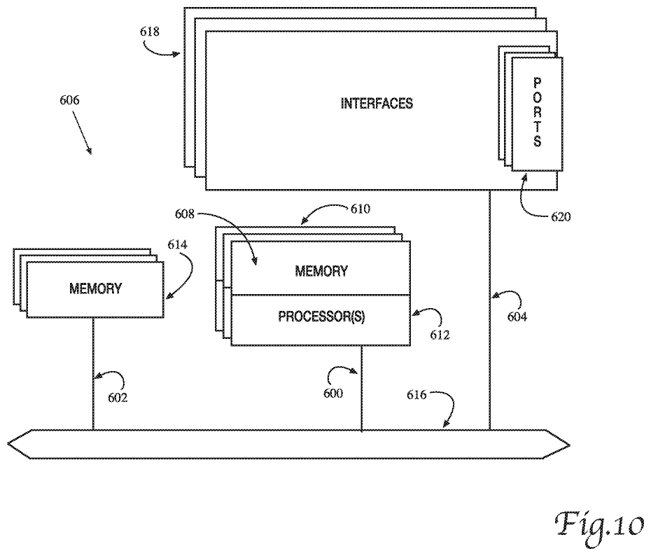

FIG. 10 illustrates an example of a network device that may be configured for implementing some methods of the present invention. Network device 606 includes a master central processing unit (CPU) 610, interfaces 618, and a bus 616 (e.g., a PCI bus). Generally, interfaces 618 include ports 620 appropriate for communication with the appropriate media. In some embodiments, one or more of interfaces 618 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 618 control such communications-intensive tasks as encryption, decryption, compression, decompression, packetization, media control and management. By providing separate processors for the communications-intensive tasks, interfaces 618 allow the master microprocessor 610 efficiently to perform other functions such as routing computations, network diagnostics, security functions, etc.

The interfaces 618 are typically provided as interface cards (sometimes referred to as “linecards”). Generally, interfaces 618 control the sending and receiving of data packets over the network and sometimes support other peripherals used with the network device 606. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 610 may be responsible for implementing specific functions associated with the functions of a desired network device. According to some embodiments, CPU 610 accomplishes all these functions under the control of software including an operating system and any appropriate applications software.

CPU 610 may include one or more processors 612 such as a processor from the Motorola family of microprocessors or the MIPS family of microprocessors. In an alternative embodiment, processor 612 is specially designed hardware for controlling the operations of network device 606. In a specific embodiment, a memory 608 (such as non-volatile RAM and/or ROM) also forms part of CPU 610. However, there are many different ways in which memory could be coupled to the system. Memory block 608 may be used for a variety of purposes such as, for example, caching and/or storing data, programming instructions, etc.

Regardless of network device's configuration, it may employ one or more memories or memory modules (such as, for example, memory block 614) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention also relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 10 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based or switch fabric based (such as a cross-bar).

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

What is claimed:

1. A video slot machine and method thereof comprising: a housing; at least one display device; at least one processor; at least one physical input device configured to detect a physical item associated with a monetary amount that establishes a credit balance; at least an electronic input device; and at least one memory device which stores a plurality of instructions which, when executed by the at least one processor, cause the at least one processor to operate with the at least one display device, and that comprises:
a) displaying a predetermined number of single-line reel slot games wherein each said reel slot game comprises a predetermined number of symbol areas and wherein the number of reels in each said reel slot game equals the number of symbol areas;
b) simultaneously displaying a multi-payline slot game, wherein the said multiline slot game comprises a predetermined number of symbol areas arranged in a column×row grid wherein the total number of symbol areas in the total number of single-line slot games equals the total number of symbol areas in the multiline slot game;
c) establishing a predetermined first paytable for the single-line reel slot games;
d) establishing a predetermined second paytable for the multiline slot game;
e) enabling a player, using the at least one electronic input device, to make a wager to play all of the single-line slot games and the multiline slot game, thereby decrementing the credit balance by the amount of the wager;
f) randomly populating a first single-line slot game with slot symbols from a predetermined set of slot symbols to provide an outcome;
g) determining, according to the first paytable, if a win is present in said first single-line slot game outcome, and providing an award for said win;
h) replicating each individual slot symbol in said first single-line slot game outcome and placing each said replicated symbol into a single available vacant symbol area in the multiline game;
i) randomly populating a second single-line slot game with slot symbols from a predetermined set of slot symbols provide an outcome;
j) determining, according to the first paytable, if a win is present in said second single-line slot game outcome, and providing an award for said win;
k) replicating each individual slot symbol in said second single-line slot game outcome and placing said each replicated symbol into a single available vacant symbol area in the multiline game;
l) randomly populating each next single-line slot game with slot symbols from a predetermined set of slot symbols to provide an outcome until a final single-line slot game is completed;
m) providing any wins for each said next and final single-line slot game outcome;
n) replicating each individual slot symbol in each next and final game outcome and placing each said replicated symbol into a single available vacant symbol area in the multiline game until all said symbol areas in the multiline game comprise a slot symbol;
o) determining, according to the second paytable, if any wins are present in said multiline slot game, and providing an award for said wins; and
p) incrementing the credit balance by the amount of any awards won in the single-line slot games and the multiline slot game.

2. The video slot machine and method of claim 1 wherein each single-line reel slot game comprises at least three reels.

3. The video slot machine and method of claim 2 wherein all single-line reel slot games comprise the same number of reels.

4. The video slot machine and method of claim 2 wherein all single-line reel slot games do not comprise the same number of reels.

5. The video slot machine and method of claim 1 wherein the multiline slot game comprises at least three paylines.

6. The video slot machine and method of claim 1 wherein five 3-reel slot games and one 5-column×3-row multiline slot game is provided.

7. The video slot machine and method of claim 1 wherein the symbols in a single-line slot game outcome are replicated and placed into the multiline slot game randomly.

8. The video slot machine and method of claim 1 wherein the symbols in a single-line slot game outcome are replicated and placed into the multiline slot game pseudo-randomly.

9. The video slot machine and method of claim 1 wherein the symbols in a single-line slot game outcome are replicated and placed into the multiline slot game non-randomly.

10. The video slot machine and method of claim 1 wherein the symbols in a single-line slot game outcome are replicated and placed into the multiline slot game according to an optimum position in the column×row grid.

11. The video slot machine and method of claim 1 wherein the wager comprises a wager on each of the single-line reel slot games plus a wager on at least one payline of the multiline slot game.

12. The video slot machine and method of claim 1 wherein the wager comprises a wager on each of the single-line reel slot games plus a wager on every payline of the multiline slot game.
